(19) United States
(12) Patent Application Publication
(10) Pub. No.: US 2026/0346782 A1
(43) Pub. Date: Nov. 5, 2026

(54) METHOD FOR OPERATING A PROJECTOR ARRANGEMENT ON A VEHICLE

(71) Applicant: MERCEDES-BENZ GROUP AG, Stuttgart (DE)

(72) Inventors: Axel MUELLER, Schorndorf (DE); Markus MAIER, Stuttgart (DE)

(21) Appl. No.: 19/477,972

(22) PCT Filed: Feb. 29, 2024
(86) PCT No.: PCT/EP2024/055278

§ 371 Date: Oct. 23, 2025

(30) Foreign Application Priority Data
Apr. 24, 2023 (DE) 10 2023 001 655.1

(51) Int. Cl. B60Q 1/24; B60Q 1/00

(52) U.S. Cl. CPC B60Q 1/247; B60Q 1/0035; B60Q 1/0041; B60Q 2400/40; B60Q 2400/50

(57) ABSTRACT

A projector arrangement includes a stationary projector and a moveable projector, both of which are mounted on a vehicle. The projector arrangement activates a single one of the projectors to projected light depending on an opening angle of an access of the vehicle.

### BACKGROUND AND SUMMARY OF THE INVENTION

Exemplary embodiments of the present invention relate to a method for operating a projector arrangement on a vehicle, which comprises a projector mounted on an access and a projector mounted stationary on the vehicle, as well as to a vehicle having such a projector arrangement.

The use of projectors on vehicles to project a light image onto the surroundings of the vehicle, usually onto the ground, is known.

A method for operating a projector on a vehicle is known from DE 10 2021 003 558 A1, in which a navigation instruction for reaching a navigation destination is displayed outside the vehicle with the projector. The projector is mounted on an access door, wherein the opening angle of the access door is taken into consideration when aligning the projection.

DE 10 2018 120 330 A1 describes a method for operating a projector arrangement on a vehicle. The projector arrangement has a projector mounted on an access door and a projector that is stationary on the vehicle. During the journey of the vehicle, an overall projection is projected onto the ground by means of the projector arrangement. This overall projection is adjusted depending on the upcoming trajectory of the vehicle.

Exemplary embodiments of the present invention are directed to improved or at least other embodiments for a method for operating a projector arrangement on a vehicle and for a vehicle having such a projector arrangement.

The present invention is accordingly based on the fundamental idea of projecting an overall projection onto the surroundings of the vehicle with projectors mounted on a vehicle, wherein one of the projectors is mounted on an access of the vehicle, and wherein the state of the access, i.e., an opening angle of the access, is taken into consideration for the overall projection. It is thus possible to create any specified overall projections independently of the respective opening angle and thus independently of the respective position of the projector mounted on the access. Thus, distortions, twists, magnifications, or reductions caused by the opening angle are balanced out in the overall projection. This leads to a controlled display and perception of the overall projection and opens up new possibilities for the use of the overall projection. Thus, both an increased quality as well as a variable use of the projector arrangement are achieved.

According to the inventive concept, the projector arrangement comprises at least one projector mounted on an access of the vehicle. The access can be adjusted to different opening angles so that the at least one projector mounted on the access is moved together with the access. The projector is also referred to as a moveable projector hereinafter. The projector arrangement also comprises at least one further projector mounted on the vehicle, which is stationary on the vehicle in contrast to the moveable projector and is also referred to as a stationary projector hereinafter. The respective projector can create an associated projection as needed, which is also referred to as a single projection hereinafter. With the method according to the invention, an overall projection is projected onto the surroundings of the vehicle using the projector arrangement. The overall projection is composed of single projections from at least one moveable projector and at least one stationary projector. Furthermore, the opening angle of the access associated with the moveable projector is monitored and the single projection from at least one projector is changed depending on the opening angle of the access.

To monitor the opening angle, the associated vehicle can comprise corresponding sensors, for example a rotary encoder at the associated access.

The respective access may be of any type. The access can, for example, be an access to a storage space of the vehicle, for example a luggage compartment lid, a hood, a trunk lid, a front trunk, and similar.

The access can similarly be an access door, in particular a front access door, which enables occupants to enter into and exit from the vehicle.

If the access is an access door, the moveable projector can be mounted, for example, on a housing of a wing mirror mounted on the access door.

The respective stationary projector can be provided on any point and on any component of the vehicle, as long as the stationary projector can project the associated single projection onto the surroundings of the vehicle. For example, at least one projector can be mounted on a headlight of the vehicle, on a sill of the vehicle, on a rear tail light of the vehicle and similar.

It is feasible that at a first opening angle of the associated access, the moveable projector projects a single projection in a projection section of the overall projection that is fixed relative to the vehicle. The first opening angle can, for example, correspond to a closed position of the access. Advantageously, the single projection from at least one projector is changed depending on the opening angle of the access in such a way that the overall projection remains unchanged in the projection section. This means that the overall projection at least in the projection section can be perceived unchanged from the outside independently of the opening angle of the access. A symbol, for example a logo, which does not change for an outside observer even when the access is moved can be displayed in the projection section. It is conceivable, for example, for a logo of the vehicle manufacturer to be displayed in the projection section, wherein the logo is retained and can be perceived independently of the position of the access, in particular of the access door.

In this variation, it is feasible that the overall projection outside of the projection section changes depending on the opening angle. Preferably, in this case, a pattern representing the opening angle is displayed outside the projection section. Advantageously, the pattern is a pattern for assisting with access to the vehicle. For example, the pattern can therefore represent and in particular highlight the path to the access and/or the position of the access, depending on the opening angle.

In an alternative variation, the single projection from at least one projector can be changed depending on the opening angle in such a way that the overall projection is retained in its entirety independently of the opening angle.

The described changes can take place due to a corresponding change of the single projection from the moveable projector that is moved with the access and/or due to a change of the single projection from another projector, in particular of a stationary projector. It is also feasible to activate or deactivate at least one of the projectors, in particular at least one stationary projector, depending on the opening angle.

In an advantageous variation, an obstacle in the surroundings of the vehicle is marked with the overall projection, in particular in the projection section. Thus, a user is visually informed that there is an obstacle located in the surroundings of the vehicle, which is to be taken into consideration when moving towards the vehicle, for example when getting into the vehicle, and/or when moving away from the vehicle, for example when exiting the vehicle. As such obstacles usually have a fixed position in relation to the vehicle, reliable marking of the obstacle and thus increased comfort and increased security is achieved with the solution according to the invention.

Marking of the obstacle expediently takes place due to prior detection of the obstacle. Detection can take place, for example, visually, in particular by means of at least one camera. The motor vehicle is designed accordingly, i.e., to have at least one camera, for example.

The obstacle may be a trip hazard, a smooth surface, a puddle, and similar, for example.

It is understood that in addition to the method, the vehicle with the projector arrangement which is operated according to the method is also included in the scope of this invention.

The vehicle preferably has an accordingly designed control device for implementing/executing the method.

Further important features and advantages of the invention result from the dependent claims, the drawings and the associated figure description according to the drawings.

It is understood that the aforementioned features and the features still to be explained in the following can not only be used in the respective specified combination, but also in other combinations or in isolation, without leaving the scope of the present invention.

Preferred exemplary embodiments of the invention are presented in the drawings and are explained in more detail in the following description, wherein the same reference signs refer to identical or similar or functionally identical components.

### BRIEF DESCRIPTION OF THE DRAWING FIGURES

The figures each schematically show:

FIG. 1 a plan view of a vehicle having an overall projection in a first position of an access,

FIG. 2 a plan view of the vehicle having the overall projection in another position of the access,

FIG. 3 a plan view of the vehicle having the overall projection in the first position in another exemplary embodiment,

FIG. 4 a plan view of the vehicle having the overall projection in another position of the access.

### DETAILED DESCRIPTION

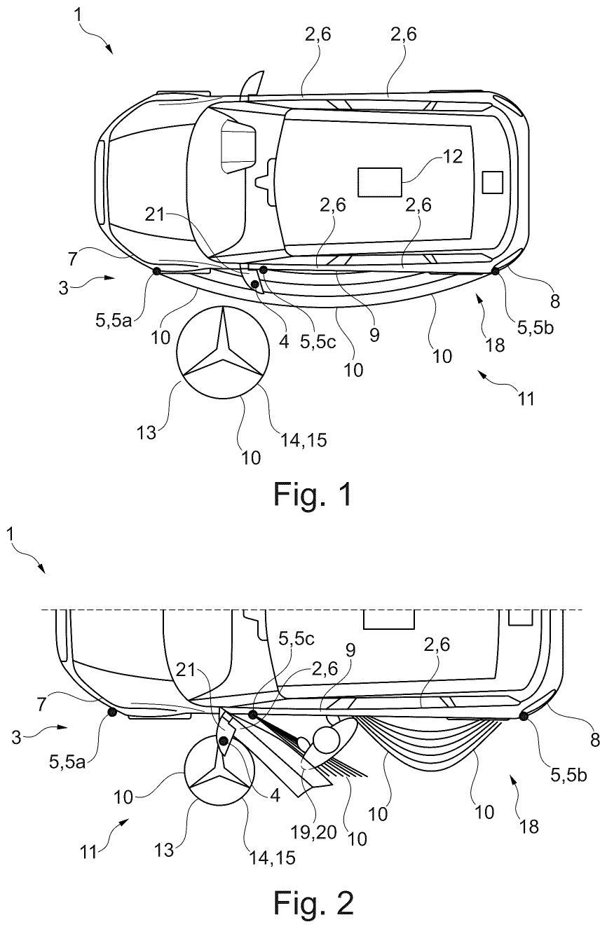

A vehicle 1, as shown by way of example in FIGS. 1 to 4, usually has at least one access 2. The access 2, as a comparison between FIGS. 1 and 2 or 3 and 4 shows, can be adjusted between different opening angles and thus positions. The vehicle 1 has a projector arrangement 3 having at least two projectors 4, 5, which cannot be seen in the figures and are only indicated. At least one of the projectors 4 is mounted on one of the associated accesses 2 and thus is moved with the access 2. The projector 4 is also hereinafter referred to as a moveable projector 4. Additionally, at least one of the projectors 5 is mounted on the vehicle 1 in a stationary manner, in contrast to the moveable projector 4, and is also hereinafter referred to as a stationary projector 5. In the exemplary embodiments shown, it is assumed for simplicity and purely by way of example that the projector arrangement 3 has a single such moveable projector 4. Additionally, in the exemplary embodiments shown, it is assumed by way of example that the access 2 on which the moveable projector 4 is mounted is an access door 6 in the front region of the vehicle 1, wherein the moveable projector 4 is mounted on a wing mirror 21 of the access door 6.

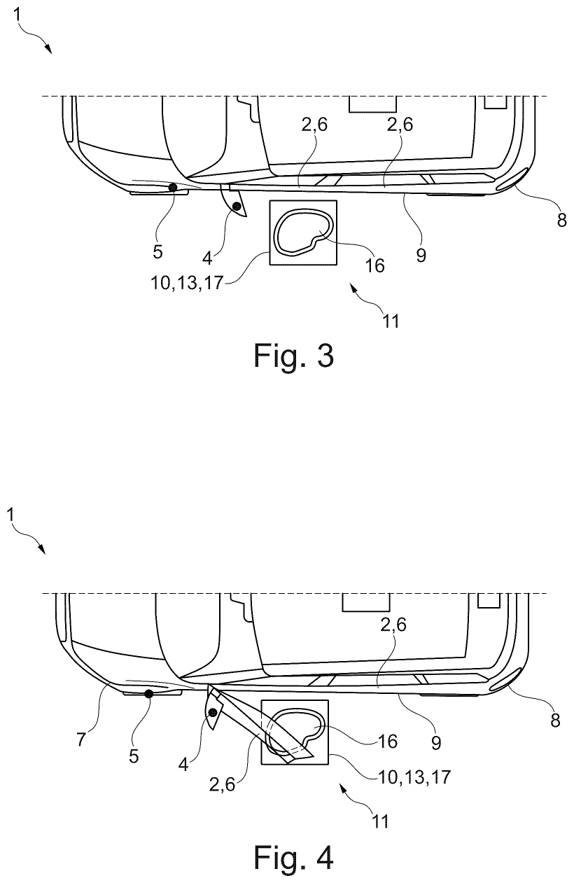

In the exemplary embodiment of FIGS. 1 and 2, the projector arrangement 3 has three stationary projectors 5, purely by way of example, wherein one of the stationary projectors 5, 5a is mounted on a headlight 7, one of the stationary projectors 5, 5b is mounted on a rear tail light 8 and one of the projectors 5, 5c is mounted on a sill 9 of the vehicle 1. In the exemplary embodiment shown in FIGS. 3 and 4, it is assumed by way of example that the projector arrangement 3 has a single stationary projector 5, which is mounted on the headlight 7.

The projectors 4, 5 are set up in each case to create an associated projection 10, which is also referred to as a single projection 10 hereinafter. The arrangement 3 creates an overall projection 11 with the single projections 10, which overall projection is projected onto the surroundings of the vehicle 1; in the exemplary embodiments shown, onto the ground in the side area of the vehicle 1. This means that an overall projection 11, which is composed of single projections 10 of at least one moveable projector 4 and at least one stationary projector 5, is projected onto the surroundings of the vehicle 1 using the projector arrangement 3. As shown in an overview of FIGS. 1 and 2 and of FIGS. 3 and 4, the opening angle of the access 2 associated with the moveable projector 4 is monitored, for example by means of a rotary encoder, not shown, and the single projection 10 of at least one projector 4, 5 is changed depending on the opening angle of the access 2.

The vehicle 1 can have a control device 12, only indicated in FIG. 1 and designed accordingly, for executing the method. The control device 12 is expediently connected to the projector arrangement 3 for communication.

The change depending on the opening angle of the access 2, as explained in the following, can take place due to a corresponding change of the single projection 10 of the moveable projector 4 and/or due to a change of the single projection 10 of at least one stationary projector 5. The change can also comprise an activation and deactivation of at least one projector 4, 5, wherein the projector 4, 5 creates a single projection 10 in the activated state and does not create a single projection 10 in the deactivated state.

In the exemplary embodiments shown, at a first opening angle of the access 2, which corresponds to a closed state of the access 2, a single projection 10 is projected in a projection section 13 of the overall projection 11 with the moveable projector 4. The projection section 13 therefore comprises the single projection 10 of the moveable projector 4 at the first opening angle. In the exemplary embodiments shown, at the first opening angle, the projection section 13 consists of the single projection 10 of the moveable projector 4 or the single projection 10 of the moveable projector 10 forms the projection section 13. In the exemplary embodiment shown in FIGS. 1 and 2, a logo 14 is displayed as a symbol 15 in the projection section 13. In the exemplary embodiments shown in FIGS. 3 and 4, an obstacle 16 indicated in the figures, for example a puddle, a trip hazard, a smooth surface and similar, in the surroundings of the vehicle 1 is marked with the projection section 13, i.e., the projection section 13 is a marking 17 of the obstacle 16.

As an overview of FIGS. 1 and 2 as well as of FIGS. 3 and 4 shows, the described changes take place depending on the opening angle in such a way that the overall projection 11 in the projection section 13 remains unchanged. In the exemplary embodiment of FIGS. 1 and 2, this means that the displayed symbol 15 remains in place independently of the opening angle and also retains the orientation. In the exemplary embodiment of FIGS. 3 and 4, marking 16 means that the marking 17 remains in place independently of an opening angle. For this purpose, the single projection 10 of at least one projector 4, 5 is changed accordingly depending on the opening angle of the access 2.

In the exemplary embodiments shown, this takes place in that, when a specified opening angle is exceeded, the projection section 13 is no longer formed by the single projection 10 of the moveable projector 4, but by the single projection 10 of one of the stationary projectors 5, in the exemplary embodiments shown, purely by way of example, the stationary projector 5, 5a mounted in the headlight 7. In the exemplary embodiments shown, the moveable projector 4 can therefore be deactivated when the specified opening angle is exceeded.

As shown in the exemplary embodiments of FIGS. 1 and 2, the overall projection 11 outside of the projection section 13 can be changed in comparison to depending on the opening angle of the access 2. This means that the overall projection 11 outside of the projection section 13 changes depending on the opening angle. In the exemplary embodiment shown in FIGS. 1 and 2, a pattern 18 is illustrated which is used for access marking to the access 2, in the present case to the access door 5. In the closed position of the access 2, which corresponds to the first opening angle, the pattern 18 substantially frames the region of the access 2, in the present case purely by way of example by means of uniform curved lines. In contrast, if the access 2 is opened, as shown in FIG. 2, the mentioned pattern 18 changes in order to show a user 19, for example a vehicle driver 20 how to enter the vehicle 1, thereby making entry easier for the user. An analogous overall projection 11 can assist with exiting from the vehicle 1. As can be seen from FIG. 2, this takes place, in the shown example, by the stationary projector 5, 5c on the sill 9 displaying radiating straight lines. Additionally, curved lines are displayed by means of the stationary projector 5, 5b mounted on the rear tail light 8 and by means of the stationary projector 5, 5c mounted on the sill 9. In the exemplary embodiment shown, a pattern 18 representing the opening angle is therefore projected and thus displayed outside the projection section 13 to assist with access.

In contrast, in the exemplary embodiment shown in FIGS. 3 and 4, the change that is dependent on the opening angle is performed in such a way that the overall projection 13 is retained independently of the opening angle.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for operating a projector arrangement comprising a stationary projector mounted on a vehicle and a moveable projector mounted on a moveable access of the vehicle, the method comprising:
projecting, by the projector arrangement into surroundings of the vehicle, an overall projection with a single projection of the stationary projector or the moveable projector;
determining an opening angle of the moveable access; and
adjusting, by the projection arrangement based on the determined opening angle of the moveable access, the single projection.

12. The method of claim 11, wherein
at a first opening angle of the moveable access the moveable projector projects the single projection in a projection section of the overall projection, wherein the projection section is fixed relative to the vehicle, and
the single projection from the moveable projector is changed depending on the opening angle of the moveable access in such a way that the overall projection remains unchanged in the projection section.

13. The method of claim 12, wherein the overall projection outside of the projection section changes depending on the opening angle.

14. The method of claim 12, wherein a symbol is displayed in the projection section.

15. The method of claim 12, wherein a pattern representing the opening angle is displayed in the overall projection outside of the projection section.

16. The method of claim 11, wherein the single projection from the stationary projector or the moveable projector is changed depending on the opening angle in such a way that the overall projection is maintained independently of the opening angle.

17. The method of claim 11, wherein the single projection from the stationary projector or the moveable projector is changed depending on the opening angle of the moveable access.

18. The method of claim 12, wherein an obstacle in the surroundings of the vehicle is marked with the overall projection.

19. The method of claim 18, wherein the obstacle is marked in the projection section.

20. A vehicle comprising:
an interior
at least one access, providing access to the interior, adjustable to different opening angles; and
a projector arrangement comprising
stationary projector mounted on the vehicle;
a moveable projector mounted on the at least one access; and
a controller configured to
control projection into surroundings of the vehicle, an overall projection with a single projection of the stationary projector or the moveable projector;
determine an opening angle of the access; and
adjusting, based on the determined opening angle of the access, the single projection.
